(19) United States
(12) Patent Application Publication
(10) Pub. No.: US 2019/0294967 A1
(43) Pub. Date: Sep. 26, 2019

(54) CIRCULANT NEURAL NETWORKS

(71) Applicant: Google Inc., Mountain View, CA (US)

(72) Inventors: Sanjiv Kumar, White Plains, NY (US); Xinnan Yu, New York, NY (US)

(21) Appl. No.: 15/014,804

(22) Filed: Feb. 3, 2016

Related U.S. Application Data
(60) Provisional application No. 62/111,597, filed on Feb. 3, 2015.

(51) Int. Cl. G06N 3/08; G06N 99/00

(52) U.S. Cl. CPC G06N 3/082; G06N 99/005

(57) ABSTRACT

Methods, systems, and apparatus, including computer programs encoded on computer storage media, for processing inputs using a neural network that includes a circulant neural network layer. One of the methods includes receiving a layer input for the circulant layer; and processing the layer input to generate a layer output for the circulant layer, wherein processing the layer input comprises computing an activation function, wherein the activation function is dependent on the product of the circulant matrix associated with the circulant layer and the layer input, and wherein computing the activation function comprises performing a circular convolution using a Fast Fourier Transform (FFT).

### CROSS-REFERENCE TO RELATED APPLICATION

This application claims priority to U.S. Provisional Application No. 62/111,597, filed on Feb. 3, 2015. The disclosure of the prior application is considered part of and is incorporated by reference in the disclosure of this application.

### BACKGROUND

This specification relates to processing inputs through the layers of a neural network to generate outputs.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

In general, one innovative aspect of the subject matter described in this specification can be embodied in methods for processing an input through each of a plurality of layers of a neural network to generate an output, wherein each of the plurality of layers of the neural network is configured to receive a respective layer input and process the layer input to generate a respective layer output, wherein each of the plurality of layers of the neural network is associated with a respective parameter matrix. For a circulant layer of the plurality of layers that is associated with a parameter matrix that is a circulant matrix, the methods can include the actions of receiving the layer input for the circulant layer; and processing the layer input to generate the layer output for the circulant layer, wherein processing the layer input comprises computing an activation function, wherein the activation function is dependent on the product of the circulant matrix associated with the circulant layer and the layer input, and wherein computing the activation function comprises converting circulant matrix multiplication to circular convolution and performing a Fast Fourier Transform (FFT).

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations the circulant matrix is a matrix that is fully specified by a single vector, wherein the single vector appears as a first row of the matrix, and wherein each subsequent row vector in the circulant matrix is a vector whose entries are rotated one entry to the right relative to a preceding row vector in the circulant matrix.

In other implementations, the circulant matrix is a matrix that is fully specified by a single vector, wherein the single vector appears as a first column of the matrix, and wherein each subsequent column in the circulant matrix is a column vector whose entries are rotated one entry below relative to a preceding column in the circulant matrix.

In some implementations each entry of the single vector is generated independently from a standard normal distribution.

In certain aspects, converting circulant matrix multiplication to circular convolution comprises replacing the product of the circulant matrix associated with the circulant layer and the layer input with the circular convolution of the single vector that fully specifies the circulant matrix and the layer input.

In additional aspects the circulant layer receives the layer input for the circulant layer from a first layer having a first number of nodes and provides the layer output to a second neural network layer having a second number of nodes, wherein the layer input is a vector with dimension equal to the first number of nodes, and wherein the layer output is a vector with dimension equal to the second number of nodes.

In some implementations the first number equals the second number, and wherein the layer output is a vector produced by computing the activation function.

In other implementations the first number is greater than the second number, and wherein processing the layer input to generate the layer output for the circulant layer comprises selecting the first k elements of the vector produced by computing the activation function as the layer output for the circulant layer, wherein k is equal to the second number.

In yet other implementations the first number is less than the second number, and wherein processing the layer input to generate the layer output for the circulant layer comprises padding k−d predetermined constant values on the end of the vector produced by computing the activation function, wherein k is equal to the second number and d is equal to the first number.

In certain aspects processing the layer input to generate the layer output for the circulant layer further comprises performing a random sign flipping on the layer input prior to computing the activation function.

In additional aspects performing the random sign flipping on the layer input comprises applying a diagonal matrix to the layer input, wherein the diagonal matrix is a matrix whose entries outside the main diagonal are all zero, and the diagonal entries on the main diagonal are Bernoulli random variables, wherein the Bernoulli random variables take the values +1 and −1 with equal probability.

The subject matter described in this specification can be implemented in particular embodiments so as to realize one or more of the following advantages. A neural network system with one or more circulant neural network layers may be both space and time efficient. A circulant neural network system may generate layer outputs from layer inputs with a reduced amount of computational processing relative to a conventional neural network that does not have any circulant neural network layers, improving the performance of neural network computations. Additionally, optimizing processes within the circulant neural network system may run faster than optimizing processes within a conventional neural network system. Due to the circulant structure of circulant neural network layers, a circulant neural network system may require less computational storage and may improve running costs. Additionally, a circulant neural network system may also provide competitive error rates. A circulant neural network system is able to efficiently model a deep neural network containing hundreds of millions of parameters.

In some implementations, a circulant neural network system may be trained more efficiently and effectively relative to a conventional neural network that does not have any circulant neural network layers. In some implementations the training of a circulant neural network may require less input training data than the training of a conventional neural network system. Additionally, a circulant neural network system may be trained to learn better representations from large amounts of data than conventional neural network systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of a circulant neural network system.

FIG. 2 is a flow diagram of an example process for generating a circulant layer output from an input.

FIG. 3 is a flow diagram of an example process for training a circulant neural network system.

Like reference numbers and designations in the various drawings indicate like elements.

### DETAILED DESCRIPTION

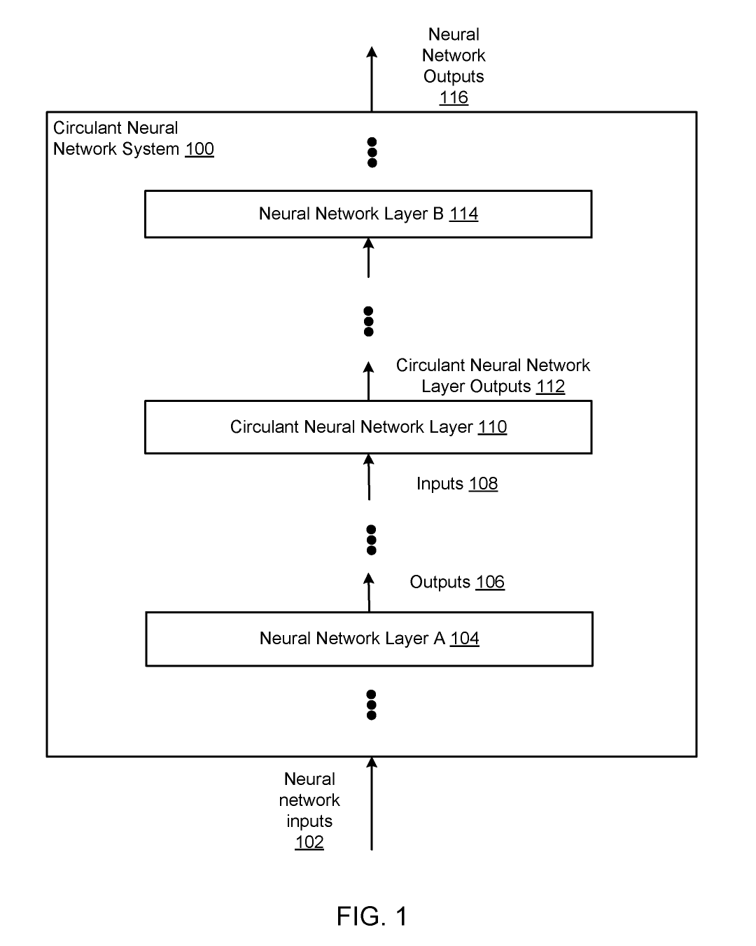

FIG. 1 shows an example circulant neural network system 100. The circulant neural network system 100 is an example of a system implemented as computer programs on one or more computers in one or more locations, in which the systems, components, and techniques described below can be implemented.

The circulant neural network system 100 is a machine learning system that receives system inputs 102 and generates system outputs 114 from the system inputs 102.

The circulant neural network system 100 can be configured to receive any kind of digital data input and to generate any kind of score or classification output based on the input. For example, if the inputs to the circulant neural network system 100 are images or features that have been extracted from images, the output generated by the circulant neural network system 100 for a given image may be scores for each of a set of object categories, with each score representing an estimated likelihood that the image contains an image of an object belonging to the category. As another example, if the inputs to the circulant neural network system 100 are Internet resources (e.g., web pages), documents, or portions of documents or features extracted from Internet resources, documents, or portions of documents, the output generated by the circulant neural network system 100 for a given Internet resource, document, or portion of a document may be a score for each of a set of topics, with each score representing an estimated likelihood that the Internet resource, document, or document portion is about the topic. As another example, if the inputs to the circulant neural network system 100 are features of an impression context for a particular advertisement, the output generated by the circulant neural network system 100 may be a score that represents an estimated likelihood that the particular advertisement will be clicked on. As another example, if the inputs to the circulant neural network system 100 are features of a personalized recommendation for a user, e.g., features characterizing the context for the recommendation, e.g., features characterizing previous actions taken by the user, the output generated by the circulant neural network system 100 may be a score for each of a set of content items, with each score representing an estimated likelihood that the user will respond favorably to being recommended the content item. As another example, if the input to the circulant neural network system 100 is text in one language, the output generated by the circulant neural network system 100 may be a score for each of a set of pieces of text in another language, with each score representing an estimated likelihood that the piece of text in the other language is a proper translation of the input text into the other language. As another example, if the input to the circulant neural network system 100 is a spoken utterance, a sequence of spoken utterances, or features derived from one of the two, the output generated by the circulant neural network system 100 may be a score for each of a set of pieces of text, each score representing an estimated likelihood that the piece of text is the correct transcript for the utterance or sequence of utterances. As another example, the circulant neural network system 100 can be part of a speech synthesis system. As another example, the circulant neural network system 100 can be part of a video processing system. As another example, the circulant neural network system 100 can be part of a dialogue system. As another example, the circulant neural network system 100 can be part of an auto-completion system. As another example, the circulant neural network system 100 can be part of a text processing system. As another example, the circulant neural network system 100 can be part of a reinforcement learning system.

In particular, the circulant neural network system 100 includes multiple neural network layers including a neural network layer A 104 and a neural network layer B 114. The neural network layers in the circulant neural network system 100 are arranged in a sequence from a lowest layer in the sequence to a highest layer in the sequence. Each of the layers of the circulant neural network is configured to receive a respective layer input and process the layer input to generate a respective layer output from the input. The neural network layers collectively process neural network inputs received by the neural network system 100 to generate a respective neural network output for each received neural network input.

Some or all of the layers of the neural network are associated with a respective parameter matrix that stores current values of the parameters of the layer. These neural network layers generate outputs from inputs in accordance with the current values of the parameters for the neural network layer. For example, some layers may multiply the received input by the respective parameter matrix of current parameter values as part of generating an output from the received input.

At least one of the neural network layers in the sequence of layers is a circulant neural network layer, e.g., circulant neural network layer 110. A circulant neural network layer is a neural network layer that is associated with a respective parameter matrix that is a circulant matrix. Generally, a circulant matrix is a matrix that is fully specified by a single vector. In particular, the single vector that fully specifies the circulant matrix appears as the first row, i.e., the top row, of the matrix. Each subsequent row of the circulant matrix is a vector whose entries are rotated one entry to the right relative to the preceding row vector in the circulant matrix.

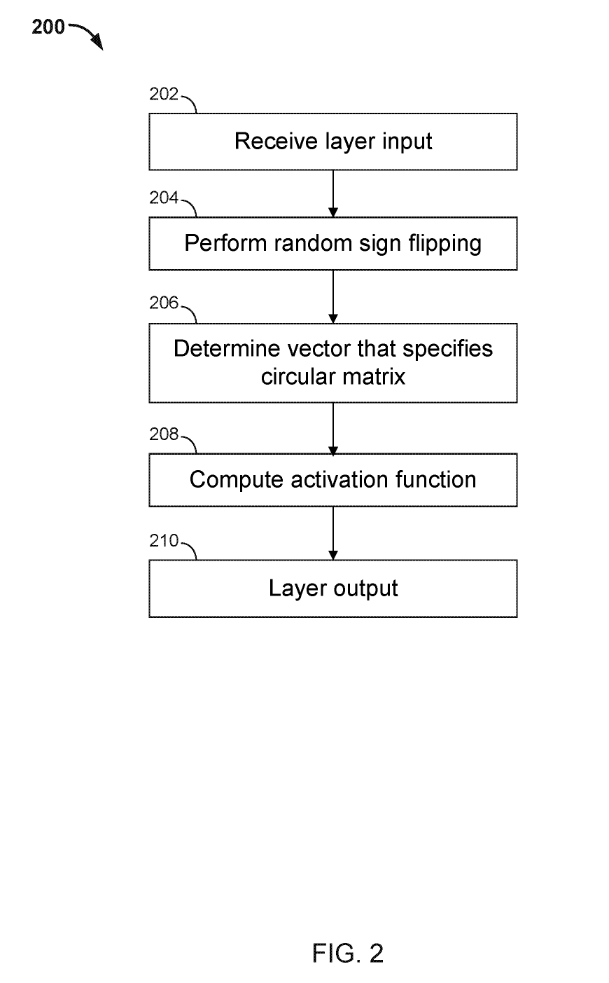

The circulant neural network layer 110 may be included at various locations in the sequence of neural network layers and, in some implementations, multiple circulant neural network layers may be included in the sequence. The circulant neural network layer 110 is configured to generate outputs by modifying inputs to the layer in accordance with current values of the parameters stored in the circulant parameter matrix for the circulant neural network layer 110. For example, the circulant neural network layer 110 can generate the output by multiplying the input to the layer by an associated circulant matrix of the current parameter values and then, optionally, applying a non-linear function to the product. Processing an input using a circulant neural network layer is described in more detail below with reference to FIG. 2.

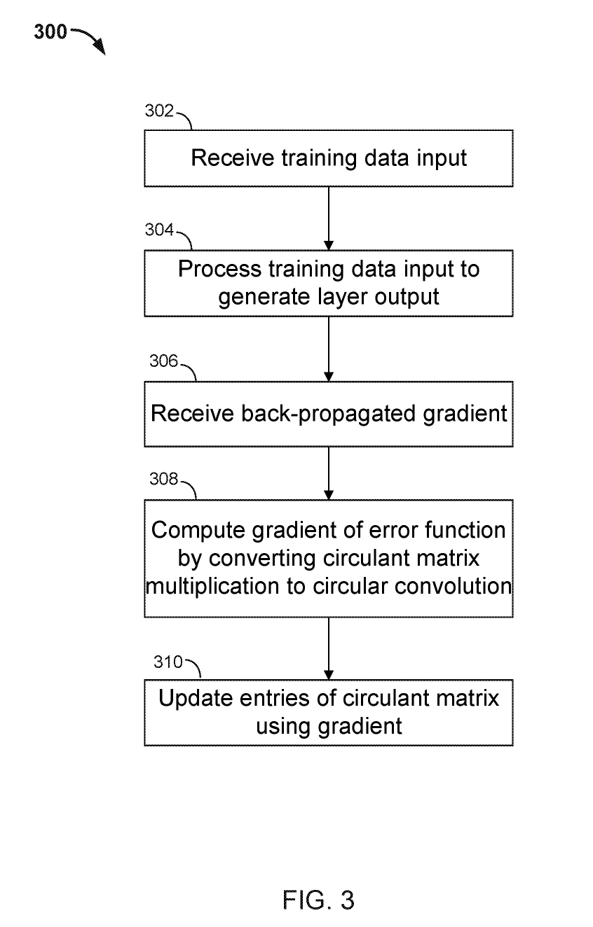

The circulant neural network system 100 can be trained on multiple batches of training examples in order to determine trained values of the parameters of the neural network layers, i.e., to adjust the values of the parameters from initial values to trained values. For example, during the training, the circulant neural network system 100 can process a batch of training examples and generate a respective neural network output for each training example in the batch. The neural network outputs can then be used to adjust the values of the parameters of the components of the circulant neural network system 100, for example, through gradient descent and back-propagation neural network training techniques. Training the neural network layers is described in more detail below with reference to FIG. 3.

Once the neural network has been trained, the circulant neural network system 100 may receive a new neural network input for processing and process the neural network input through the neural network layers to generate a new neural network output for the input in accordance with the trained values of the parameters of the components of the circulant neural network system 100.

FIG. 2 is a flow diagram of an example process for generating a circulant layer output from an input. For convenience, the process 200 will be described as being performed by a system of one or more computers located in one or more locations. For example, a circulant neural network system, e.g., the circulant neural network system 100 of FIG. 1, appropriately programmed in accordance with this specification, can perform the process 200.

The system receives a layer input x for a circulant neural network layer, e.g., the circulant neural network layer 110 of FIG. 1 (step 202). The layer input can, for example, be an output generated by the layer preceding the circulant neural network layer in a sequence of neural network layers.

Optionally, the system performs a random sign flipping on the layer input x (step 204). To perform the random sign flipping, the system applies a diagonal matrix D to the layer input. The diagonal matrix is a matrix whose entries outside the main diagonal are all zero. In some implementations, the diagonal entries on the main diagonal are Bernoulli random variables taking the values of +1 and −1 with equal probability.

The system determines the vector r that specifies the circulant matrix R associated with the circulant neural network layer (step 206). The circulant matrix R stores current values of the parameters of the circulant neural network layer. For example, for a circulant neural network layer with d parameters, the vector r=(r₀, r₁, . . . , r_{d-1}) defines the circulant matrix R∈ [symbol] ^{d×d} as given by equation (1) below. In some implementations, the entries of the circulant matrix are generated independently from a standard normal distribution. In some other implementations, the entries of the circulant matrix are learned through training the circulant neural network layer, e.g., as described below with reference to FIG. 3.

$$R = circ ( r ) = ( \begin{matrix}{r}_{0} & {r}_{d - 1} & … & {r}_{1} \\ {r}_{1} & {r}_{0} & … & ⋮ \\ ⋮ & {r}_{1} & ⋱ & ⋮ \\ {r}_{d - 1} & ⋮ & … & {r}_{0}\end{matrix} ) \qquad ( 1 )$$

The system computes an activation function h(x) to generate the circulant neural network layer output (step 208). The activation function is dependent on the product of the circulant matrix R and the layer input x or, if the pre-processing step is performed, the layer input after the random sign flipping has been performed, as given by equation (2) below.

h(x)=φ(RDx), R=circ(r) (2)

In equation (2), φ(.) is an element-wise non-linear activation function, e.g., the sigmod function or the ReLU (rectified linear unit) function. The activation function h(x) is computed using the circulant structure of the circulant matrix R. The circulant matrix multiplication computation RDx is converted to a circular convolution computation r⊙Dx. The circular convolution is computed more efficiently in the Fourier domain, using the Discrete Fourier Transform (DFT) for which a Fast Fourier Transform (FFT) algorithm is available. The system therefore performs a FFT to compute the activation function shown below in equation (3) and produce a layer output.

h(x)=φ(RDx)=φ(( [symbol] ⁻¹( [symbol] (r)º [symbol] (Dx))) (3)

In equation (3), [symbol] (.) is the operator of the DFT, and [symbol] ⁻¹(.) is the operator of the inverse DFT. The DFT and inverse DFT can be efficiently computed with time complexity [symbol] (d log d) using a FFT algorithm. In addition, computational resources are reduced since the circulant matrix R is never explicitly computed or stored. Furthermore, the amount of storage space required to store the data that defines the circulant neural network layer is reduced relative to the amount of storage space required to store the data that defines a conventional neural network layer. In particular, storing r and the diagonal entries of D takes [symbol] (d) space.

The system produces a layer output for the circulant neural network layer using the computed activation function (step 210). The dimension of the layer output is dependent on the structure of the circulant neural network system. In particular, the circulant neural network layer receives the layer input x from the layer preceding the circulant neural network layer in the sequence of neural network layers (the “input layer”) and provides the layer output generated by the circulant neural network layer, e.g., layer output 112 in FIG. 1, to the layer following the circulant neural network layer in the sequence of neural network layers (the “output layer”).

Generally, the input layer generates a d-dimensional output, e.g., a d-dimensional vector, and the output layer is configured to receive a k-dimensional input, e.g., a k-dimensional vector. In some cases d k. In these cases, the system uses the activation function output produced by performing the FFT as the layer output for the circulant neural network layer. In some cases d>k. In these cases, the circulant neural network layer performs a compression of the computed layer output. That is, the system provides the first k elements of the activation function output produced by performing the FFT as the layer output for the circulant neural network layer. In some cases d<k. In some implementations, in these cases, the layer performs an expansion of the layer output and the system generates the layer output from the activation function output produced by performing the FFT by padding k−d zeros or other predetermined constant values on the end of the activation function output produced by performing the FFT. In some other implementations, in these cases the system uses multiple circulant projections and concatenates the output of the circulant projections to generate the layer output for the circulant neural network layer.

Once the output has been generated, the system can, e.g., provide the output as input to the layer following the circulant neural network layer in the sequence of neural network layers.

The system can perform the process 200 as part of processing a neural network input through the sequence of neural network layers to generate a neural network output for the neural network input. For example, the system can receive an input and process the input using one or more neural network layers to generate the input for the circulant neural network layer. The system can then process the output of the circulant neural network layer using each of the remaining neural network layers in the sequence to generate the neural network output or, if the circulant neural network layer is the last layer in the sequence, provide the output of the circulant neural network layer as the neural network output.

The process 200 can be performed for a neural network input for which the desired output, i.e., the neural network output that should be generated by the system for the input, is not known. The system can also perform the process 200 on inputs in a set of training data, i.e., a set of inputs for which the output that should be predicted by the system is known, in order to train the system, i.e., to determine trained values for the parameters of the circulant neural network layer and the other neural network layers in the sequence. In particular, the process 200 can be performed repeatedly on inputs selected from a set of training data as part of a machine learning training technique to train the neural network, e.g., a stochastic gradient descent back-propagation training technique. An example training process for a circulant neural network system is described in more detail below with reference to FIG. 3.

FIG. 3 is a flow diagram of an example process for training a circulant neural network layer. For convenience, the process 300 will be described as being performed by a system of one or more computers located in one or more locations. For example, a circulant neural network system, e.g., the circulant neural network system 100 of FIG. 1, appropriately programmed in accordance with this specification, can perform the process 300.

The system receives training data input t for a circulant neural network layer, e.g., the circulant neural network layer 110 of FIG. 1 (step 302). The training data input can, for example, be an output generated by the layer preceding the circulant neural network layer in a sequence of neural network layers.

The system processes the training data input to generate a training data layer output for the circulant neural network layer, e.g., as described above with reference to FIG. 2 and (step 304). Once the training data layer output has been generated, the system can provide the training data layer output as training data input to the layer above the circulant neural network layer in the sequence of neural network layers.

The system receives a back-propagated gradient for the circulant neural network layer from the layer above the circulant neural network layer in the sequence of neural network layers (step 306). The back-propagated gradient can be generated by computing the gradient for the top layer in the sequence and then backpropagating the computed gradient through the layers using back-propagation techniques.

The system computes the gradient of an error function with respect to the current values of the circulant neural network layer parameters (step 308). The error function is dependent on the product of the circulant matrix associated with the circulant neural network layer and the received back-propagated gradient. The gradient may be computed using the circulant structure of the circulant matrix R. The circulant matrix multiplication computation is converted to a circular convolution computation. The circular convolution is computed more efficiently in the Fourier domain, using the Discrete Fourier Transform (DFT) for which a Fast Fourier Transform (FFT) algorithm is available. The system therefore performs a FFT to compute the gradient of the error function. The DFT and inverse DFT can be efficiently computed with time complexity [symbol] (d log d) using a FFT algorithm.

The system updates the entries of the circulant matrix associated with the circulant neural network layer using the computed gradient (step 310). The system can update the values of the vector that fully specifies the circulant matrix using machine learning training techniques, e.g., by summing the gradient and the vector or by multiplying the gradient by a learning rate and then adding the product to the vector.

The training process 300 can be performed for each training input in a batch of training inputs in order to determine trained values of the circulant neural network system, including trained values of the entries of the circulant matrices associated with the circulant neural network layers of the circulant neural network system.

In some implementations, instead of repeatedly performing the process 300 to determine trained values of the parameters of the circulant neural network layers, the entries of the vectors that fully specify the circulant matrices associated with the circulant neural network layers are generated randomly, e.g., independently from a standard normal distribution.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method for processing an input through each of a plurality of layers of a neural network to generate an output, wherein the plurality of layers comprises a circulant layer that is associated with a parameter matrix that is a circulant matrix, and wherein the method comprises:
receiving, by one or more computers, a layer input for the circulant layer;
identifying, by the one or more computers, the parameter matrix for the circulant layer, wherein the parameter matrix is fully specified by a single vector;
determining, by the one or more computers, a product between the parameter matrix and the layer input to the circulant layer, comprising performing a circular convolution between the single vector that fully specifies the parameter matrix and the layer input using a Fast Fourier Transform (FFT) in place of a multiplication between the parameter matrix and the layer input; and
computing, by the one or more computers, an activation function that is dependent on the product of the parameter matrix and the layer input to generate a layer output for the circulant layer.

2. The method of claim 1, wherein the single vector appears as a first row of the matrix, and wherein each subsequent row vector in the circulant matrix is a vector whose entries are rotated one entry to the right relative to a preceding row vector in the circulant matrix.

3. The method of claim 1, wherein the single vector appears as a first column of the matrix, and wherein each subsequent column in the circulant matrix is a column vector whose entries are rotated one entry below relative to a preceding column in the circulant matrix.

4. (canceled)

5. The method of claim 1, wherein the circulant layer receives the layer input for the circulant layer from a first layer having a first number of nodes and provides the layer output to a second neural network layer having a second number of nodes, wherein the layer input is a vector with dimension equal to the first number of nodes, and wherein the layer output is a vector with dimension equal to the second number of nodes.

6. The method of claim 5, wherein the first number equals the second number, and wherein the layer output is a vector produced by computing the activation function.

7. The method of claim 5, wherein the first number is greater than the second number, and wherein the layer output is the first k elements of a vector produced by computing the activation function as the layer output, wherein k is equal to the second number.

8. The method of claim 5, wherein the first number is less than the second number, and wherein computing the activation function to generate the layer output for the circulant layer comprises padding k−d predetermined constant values on the end of the vector produced by computing the activation function, wherein k is equal to the second number and d is equal to the first number.

9. The method of claim 1, wherein determining a product between the parameter matrix and the layer input to the circulant layer further comprises performing a random sign flipping on the layer input prior to determining the product.

10. The method of claim 9, wherein performing the random sign flipping on the layer input comprises applying a diagonal matrix to the layer input, wherein the diagonal matrix is a matrix whose entries outside the main diagonal are all zero, and the diagonal entries on the main diagonal are Bernoulli random variables, wherein the Bernoulli random variables take the values +1 and −1 with equal probability.

11. The method of claim 1, wherein each entry of the single vector is generated independently from a standard normal distribution.

12.

13. A method for training a neural network that includes a plurality of neural network layers on a plurality of training data inputs, wherein the plurality of neural network layers includes a circulant neural network layer that is associated with a parameter matrix that is a circulant matrix, and wherein the method comprises, for each plurality of training data inputs and for the circulant layer:
receiving, by one or more computers, the training data input for the circulant layer;
processing, by the one or more computers, the training data input to generate a layer output for the circulant layer, comprising:
identifying the parameter matrix for the circulant layer, wherein the parameter matrix is a circulant matrix that is fully specified by a single vector;
determining a product between the parameter matrix and the training data input to the circulant layer, comprising performing a circular convolution between the single vector that fully specifies the parameter matrix and the training data input using a Fast Fourier Transform (FFT) in place of a multiplication between the parameter matrix and the training data input, and
computing an activation function that is dependent on the product of the parameter matrix and the training data input to generate a layer output for the circulant layer;
receiving, by the one or more computers, a back-propagated gradient for the training data input from the neural network layer above the circulant layer;
computing, by the one or more computers, the gradient of an error function for the circulant layer, wherein the error function is dependent on the product of the circulant matrix associated with the circulant layer and the received back-propagated gradient, and wherein computing the gradient of the error function comprises converting circulant matrix multiplication to circular convolution and performing a Fast Fourier Transform (FFT); and
updating, by the one or more computers, the entries of the circulant matrix associated with the circulant layer using the computed gradient.

14. The method of claim 13 wherein the single vector appears as a first row of the matrix, and wherein each subsequent row vector in the circulant matrix is a vector whose entries are rotated one entry to the right relative to a preceding row vector in the circulant matrix.

15. The method of claim 13, wherein the single vector appears as a first column of the matrix, and wherein each subsequent column in the circulant matrix is a column vector whose entries are rotated one entry below relative to a preceding column in the circulant matrix.

16. The method of claim 13, wherein converting circulant matrix multiplication to circular convolution comprises replacing the product of the circulant matrix associated with the circulant layer and the training data input with the circular convolution of the single vector that fully specifies the circulant matrix and the training data input.

17. A neural network system implemented by one or more computers, the neural network system comprising:
a circulant neural network layer, wherein the circulant layer is associated with a parameter matrix that is a circulant matrix, and wherein the circulant neural network layer is configured to, during processing of an input to the neural network system to generate an output from the input, perform operations comprising:
receiving a layer input for the circulant layer;
identifying the parameter matrix for the circulant layer, wherein the parameter matrix is fully specified by a single vector;
determining a product between the parameter matrix and the layer input to the circulant layer, comprising performing a circular convolution between the single vector that fully specifies the parameter matrix and the layer input using a Fast Fourier Transform (FFT) in place of a multiplication between the parameter matrix and the layer input; and
computing an activation function that is dependent on the product of the parameter matrix and the layer input to generate a layer output for the circulant layer.

18. The neural network system of claim 17, wherein the single vector appears as a first row of the matrix, and wherein each subsequent row vector in the circulant matrix is a vector whose entries are rotated one entry to the right relative to a preceding row vector in the circulant matrix.

19. The neural network system of claim 17, wherein the single vector appears as a first column of the matrix, and wherein each subsequent column in the circulant matrix is a column vector whose entries are rotated one entry below relative to a preceding column in the circulant matrix.

20. (canceled)
